(19) United States
(12) Patent Application Publication
(10) Pub. No.: US 2006/0230088 A1
(43) Pub. Date: Oct. 12, 2006

(54) Shift register circuit

(75) Inventor: Jung-Zone Chen, Hsinhua (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Himax Technologies, Inc.

(21) Appl. No.: 11/183,514

(22) Filed: Jul. 18, 2005

(30) Foreign Application Priority Data
Apr. 6, 2005 (TW) 94110912

(51) Int. Cl. G06F 7/00

(52) U.S. Cl. 708/209

(57) ABSTRACT

The present invention discloses a shift register circuit, comprising a plurality of shift register units and a switching circuit. The shift register units are electrically connected in series. The switching circuit electrically connects to the shift register units to divide the shift register units into a first group of shift register units and a second group of shift register units. In the shift register circuit of the present invention, the switching circuit electrically connects the first and the second group of shift register units or electrically disconnects the first group of shift register units from the second group of shift register units according to at least one control signal.

### RELATED APPLICATIONS

The present application is based on, and claims priority from, Taiwan Application Serial Number 94110912, filed Apr. 6, 2005, the disclosure of which is hereby incorporated by reference herein in its entirety.

### FIELD OF THE INVENTION

The present invention relates to a shift register circuit, and more particularly, to a shift register circuit with unidirectional/bidirectional transmitting functionality.

### BACKGROUND OF THE INVENTION

Liquid crystal displays (LCD) have been widely applied in electrical products due to the rapid progress of optical and semiconductor technologies. Moreover, with their advantages of high image quality, compact size, light weight, low driving voltage and low power consumption, LCDs have been introduced into portable computers, personal digital assistants and color televisions and are becoming the mainstream display apparatus.

In liquid crystal displays, a source driver is used to convert a digital signal to an analog voltage to transmit the image signal to the display, so it is also called the data driver. To orderly pass the signals, the source driver comprises a shift register circuit composed of a plurality of shift register units electrically connected in series. The shift register circuit can output an enable signal to enable the digital image signals to orderly load into a corresponding latch. Then, the digital image signals are sent to a digital-to-analog converting circuit from the latch to convert them into analog driving signals to drive the liquid crystal display.

Reference is made to FIG. 1a illustrating the transmission of the signals of the source driver and the timing controller of the conventional liquid crystal display, and FIG. 1b showing the block diagram of the shift register circuit of the conventional source driver. In the conventional liquid crystal display, the timing controller 104 transmits a signal to each source driver 106 electrically connected to the liquid crystal display panel 102. Then, the signal is left-shifted or right-shifted by the shift register circuit in the source driver 106. As shown in FIG. 1b, the shift register circuit in the conventional source driver 106 has an input 114, an input 118, an output 116, an output 120 and a plurality of shift register units 112 electrically connected in series. When the signal transmitted by the timing controller 104 is input from the input 114, the signal is right-shifted by the shift register units 112 and is output from the output 116. When the signal is input from the input 118, the signal is left-shifted by the shift register units 112 and is output from the output 120. Therefore, the shift register circuit in the source driver 106 has only unidirectional transmitting functionality and can only right-shift or left-shift the signal in one direction. Accordingly, the timing controller 104 can only transmit the signal into the source drivers 106 located at both ends via the route 132 or route 134, as shown in FIG. 1a.

### SUMMARY OF THE INVENTION

Therefore, one objective of the present invention is to provide a shift register circuit comprising a switching circuit, and by switching on or off the switching circuit, the shift register circuit may have unidirectional or bidirectional transmitting functionality.

Another objective of the present invention is to provide a shift register circuit with unidirectional/bidirectional transmitting functionality, which may be applied in a source driver to enable the timing controller to input the signal to the source driver anywhere located and further to conserve the usage of the soft printed-circuit-boards.

According to the aforementioned objectives, the present invention provides a shift register circuit comprising a plurality of shift register units and a switching circuit. The shift register units are electrically connected in series. The switching circuit electrically connects between the shift register units to divide the shift register units into a first group of shift register units and a second group of shift register units. In the shift register circuit of the present invention, the switching circuit electrically connects the first and the second groups of shift register units or electrically disconnects the first group of shift register units from the second group according to at least one control signal.

According to the preferred embodiment of the present invention, the shift register circuit is a unidirectional shift register circuit or a bidirectional shift register circuit, and the shift register units are bidirectional shift register units. The lengths of the first group of shift register units and the second group of shift register units are the same or different. The shift register circuit of the present invention further comprises a first input and a first output electrically connected to the first group of shift register units and a second input and a second output electrically connected to the second group of shift register units.

According to another objective, the present invention provides an operation method of a shift register circuit, wherein the shift register circuit comprises a first group of shift register units, a second group of shift register units and a switching circuit electrically connected in series, in which the switching circuit is between the first group of shift register units and the second group of shift register units. The operation method of the shift register circuit comprises the following steps. At least one control signal is provided to make the switching circuit electrically connect or electrically disconnect the first group of shift register units from the second group of shift register units. If the switching circuit electrically connects the first group of shift register units and the second group of shift register units, a first signal inputting to an input of the first group of shift register units outputs from an output of the second group of shift register units. If the switching circuit electrically disconnects the first group of shift register units from the second group of shift register units, the first signal inputting to the input of the first group of shift register units outputs from an output of the first group of shift register units.

According to the preferred embodiment of the present invention, the shift register circuit is a unidirectional shift register circuit or a bidirectional shift register circuit, and the shift register units are bidirectional shift register units. The lengths of the first group of shift register units and the second group of shift register units are the same or different. The shift register circuit of the present invention further comprises a first input and a first output electrically connected to the first group of shift register units and a second input and a second output electrically connected to the second group of shift register units.

According to the objectives, the present invention provides a driving circuit of a display, comprising a shift register circuit, a latch circuit and a digital-to-analog converting circuit. The latch circuit couples to the shift register circuit, and the digital-to-analog converting circuit couples to the latch circuit. The shift register circuit comprises a plurality of shift register units electrically connected in series and a first switching circuit. The first switching circuit is electrically connected between the shift register units to divide the shift register units into a first group of shift register units and a second group of shift register units, wherein the first switching circuit selectively conducts the first group of shift register units and the second group of shift register units.

According to the preferred embodiment of the present invention, the shift register units are used to receive a signal and orderly pass the signal. The first group of shift register units is used to receive a first signal and the second group of shift register units is used to receive a second signal, in which the directions for passing the first signal and the second signal are different or the same. Furthermore, the numbers of the shift register units in the first group of shift register units and the second group of shift register units are different or the same.

According to the preferred embodiment of the present invention, the driving circuit further comprises a second switching circuit electrically connected between the second group of shift register units to divide the second group of shift register units into a third group of shift register units and a fourth group of shift register units, wherein the second switching circuit selectively disconnects the third group of shift register units from the fourth group of shift register units.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1a illustrates the transmitting of the signals of the source driver and the timing controller of the conventional liquid crystal display;

FIG. 1b illustrates a block diagram of the shift register circuit of the conventional source driver;

FIG. 2a illustrates the driving circuit of a display according to the preferred embodiment of the present invention; and

FIG. 2b illustrates the block diagram of the shift register circuit according to the preferred embodiment of the present invention.

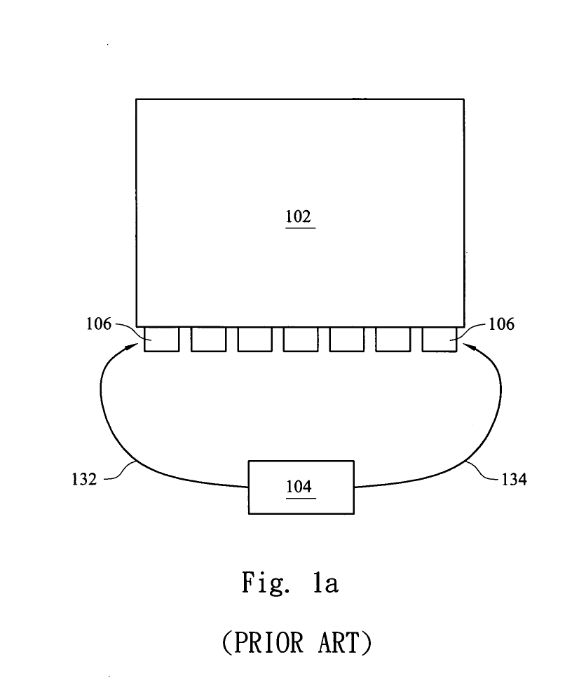

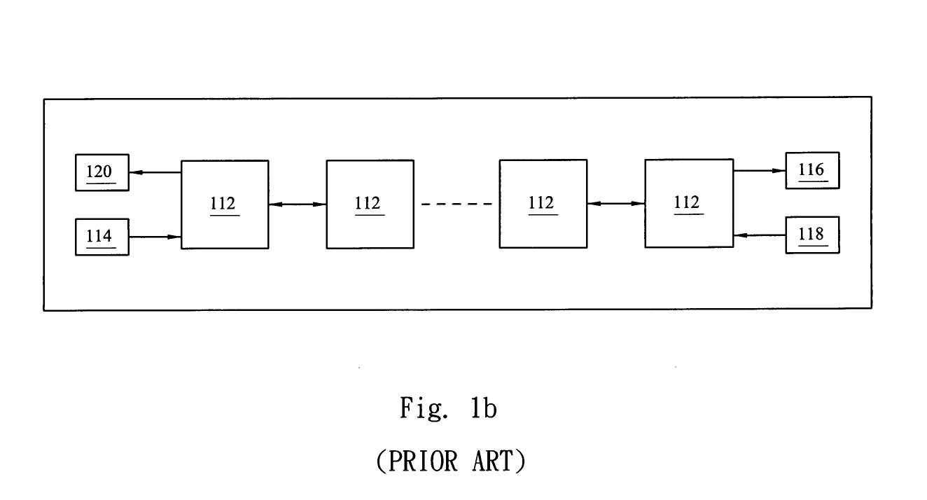

### DETAILED DESCRIPTION OF THE PREFERRED EMBODIMENT

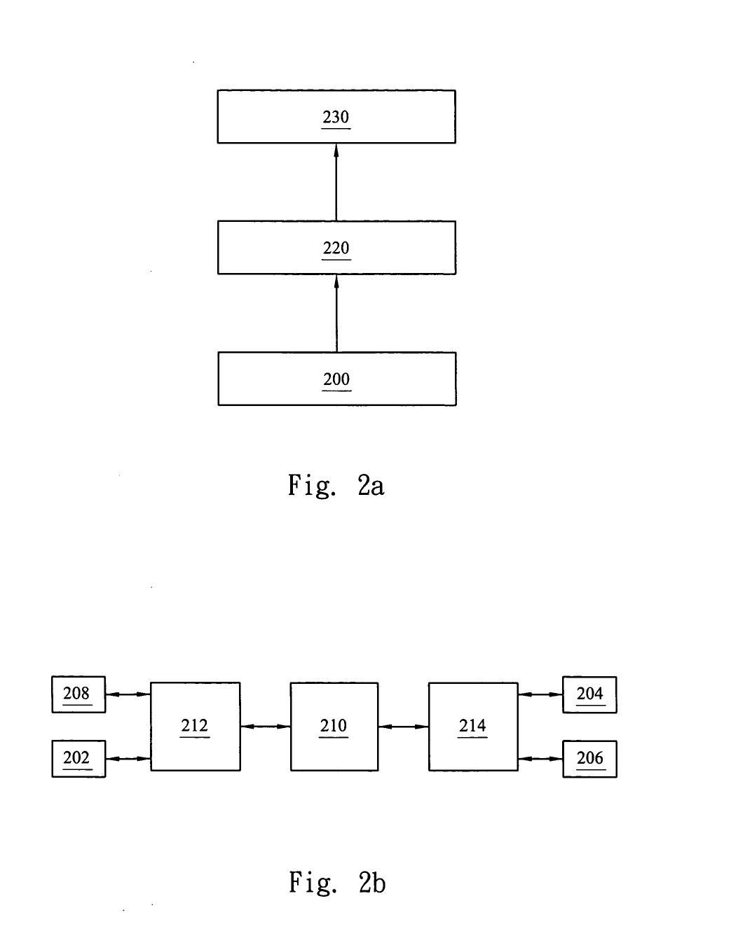

In order to make the illustration of the present invention more explicit and complete, the following description is stated with reference to FIG. 2a and FIG. 2b.

FIG. 2a illustrates the driving circuit of a display according to the preferred embodiment of the present invention. The driving circuit of the display in the preferred embodiment of the present invention comprises a shift register circuit 200, a latch circuit 220 and a digital-to-analog converting circuit 230. The shift register circuit 200 couples to the latch circuit 220, and the latch circuit 220 couples to the digital-to-analog converting circuit 230. The shift register circuit 200 can output an enable signal to enable the digital image signals to orderly load into the corresponding latch circuit 220. Then, the digital image signals are sent to the digital-to-analog converting circuit 230 from the latch circuit 220 to convert them into analog driving signals to drive the liquid crystal display.

FIG. 2b illustrates a block diagram of the shift register circuit according to the preferred embodiment of the present invention. The shift register circuit in the preferred embodiment of the present invention comprises a plurality of shift register units electrically connected in series, an input 202, an input 206, an output 204, an output 208 and a switching circuit 210. The switching circuit 210 has at least one switch. The switching circuit 210 electrically connects between the shift register units to divide the shift register units into a first group of shift register units 212 and a second group of shift register units 214. The lengths of the first group of shift register units 212 and the second group of shift register units 214 may be the same or different, i.e. the numbers of the shift register units in the first group of shift register units 212 and the second group of shift register units 214 may be the same or different. The input 202 and the output 208 electrically connect to the first group of shift register units 212, and the input 206 and the output 204 electrically connect to the second group of shift register units 214, as shown in FIG. 2b. In the preferred embodiment of the present invention, the shift register circuit of the present invention may have either unidirectional or bidirectional transmitting functionality by switching on or off the switching circuit 210. The unidirectional/bidirectional transmitting functionality of the shift register circuit in the preferred embodiment of the present invention is described in further detail as follows.

As shown in FIG. 2b, when the shift register circuit is set for unidirectional transmitting, at least one control signal is used to switch on the switching circuit 210, and thus, the switching circuit 210 electrically connects the first group of shift register units 212 to the second group of shift register units 214. Consequently, when the signal is input from the input 202, the signal can be right-shifted by the first group of shift register units 212 and the second group of shift register units 214 and then output from the output 204. Similarly, when the signal is input from the input 206, the signal can be left-shifted by the second group of shift register units 214 and the first group of shift register units 212 and then output from the output 208.

Contrarily, when the shift register circuit is set for bidirectional transmitting, a least one control signal is used to switch off the switching circuit 210, and thus, the switching circuit 210 electrically disconnects the first group of shift register units 212 from the second group of shift register units 214 to make them two independent parts. Consequently, when the signal is input from the input 202, since the switching circuit 210 is off, the signal is transmitted through the first group of shift register units 212 and then output from the output 208. Similarly, when the signal is input from the input 206, the signal is transmitted through the second group of shift register units 214 and then output from the output 204.

Moreover, if the input 202, the input 206, the output 204 and the output 208 are set to be either input or output, then a signal can be left-shifted or right-shifted in the first group of shift register units and another signal can further be left-shifted or right-shifted in the second group of shift register units. That is, the first and the second group of shift register units may operate left-shifting or right-shifting, respectively, or at the same time. There are four kinds of signal-transmitting modes(left/right, right/left, left/left, right/right), which can be applied in different uses.

Hence, a feature of the present invention is that the shift register circuit in the preferred embodiment of the present invention has a switching circuit, and by switching on or off the switching circuit, the shift register circuit may have unidirectional/bidirectional transmitting functionality.

Furthermore, since the shift register circuit in the preferred embodiment of the present invention has unidirectional/bidirectional transmitting functionality, if the shift register circuit is further used in the source driver, the timing controller may input the signal to the source driver anywhere located and use at lease one control signal to control the on/off state of the switching circuit to make the signal transmit unidirectionally or bidirectionally and further to conserve the usage of the soft printed-circuit-boards.

In the preferred embodiment of the present invention, the shift register units comprise a plurality of shift registers, such as delay-type flip flops (DFF).

In other embodiments of the present invention, the switching circuit in the shift register circuit does not need to be positioned such that it symmetrically divides the shift register units but can be positioned elsewhere. Moreover, the shift register circuit may have a plurality of switching circuits located between a plurality of shift register units to divide the shift register units into a plurality of groups of shift register units, such as a first and a second switching circuits divide the shift register units into a first, second and third groups of shift register units. Similarly, the positions to locate the switching circuits may be arbitrary, and the number of the shift register units in each group of shift register units may be different.

According to the aforementioned description, one advantage of the present invention is that the shift register circuit of the present invention may have unidirectional or bidirectional transmitting functionality by switching on or off the switching circuit.

According to the aforementioned description, yet another advantage of the present invention is that the shift register circuit of the present invention may be used in the source driver, so the timing controller may input the signal to the source driver anywhere located and use at least one control signal to control the on/off state of the switching circuit to define the transmitting mode of the signal and further to conserve the usage of the soft printed-circuit-boards.

As is understood by a person skilled in the art, the foregoing preferred embodiments of the present invention are illustrative of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A shift register circuit, comprising:
a plurality of shift register units, electrically connected in series; and
a switching circuit, electrically connected between the shift register units to divide the shift register units into a first group of shift register units and a second group of shift register units;
wherein the switching circuit electrically connects the first group of shift register units and the second group of shift register units or electrically disconnects the first group of shift register units from the second group of shift register units according to at least one control signal.

2. The shift register circuit according to claim 1, wherein the shift register circuit is a unidirectional shift register circuit or a bidirectional shift register circuit.

3. The shift register circuit according to claim 1, wherein the shift register units are bidirectional shift register units.

4. The shift register circuit according to claim 1, wherein the lengths of the first group of shift register units and the second group of shift register units are the same.

5. The shift register circuit according to claim 1, wherein the lengths of the first group of shift register units and the second group of shift register units are different.

6. The shift register circuit according to claim 1, further comprising a first input and a first output electrically connected to the first group of shift register units and a second input and a second output electrically connected to the second group of shift register units.

7. An operation method of a shift register circuit, wherein the shift register circuit comprises a first group of shift register units, a second group of shift register units and a switching circuit electrically connected in series, in which the switching circuit is between the first group of shift register units and the second group of shift register units, the operation method of the shift register circuit comprising:
providing at least one control signal to make the switching circuit electrically connect or electrically disconnect the first group of shift register units from the second group of shift register units;
if the switching circuit electrically connects the first group of shift register units and the second group of shift register units, a first signal inputting to an input of the first group of shift register units outputs from an output of the second group of shift register units; and
if the switching circuit electrically disconnects the first group of shift register units from the second group of shift register units, the first signal inputting to the input of the first group of shift register units outputs from an output of the first group of shift register units.

8. The operation method of the shift register circuit according to claim 7, wherein the shift register circuit is a unidirectional shift register circuit or a bidirectional shift register circuit.

9. The operation method of the shift register circuit according to claim 7, wherein the first group of shift register units and the second group of shift register units are bidirectional shift register units.

10. The operation method of the shift register circuit according to claim 7, wherein the lengths of the first group of shift register units and the second group of shift register units are the same.

11. The operation method of the shift register circuit according to claim 7, wherein the lengths of the first group of shift register units and the second group of shift register units are different.

12. A driving circuit of a display, comprising:
a shift register circuit, comprising:
a plurality of shift register units, electrically connected in series; and
a first switching circuit, electrically connected between the shift register units to divide the shift register units into a first group of shift register units and a second group of shift register units wherein the first switching circuit selectively disconnects the first group of shift register units from the second group of shift register units;
a latch circuit, coupled to the shift register circuit; and
a digital-to-analog converting circuit, coupled to the latch circuit.

13. The driving circuit according to claim 12, wherein the shift register units are used to receive a signal and orderly pass the signal.

14. The driving circuit according to claim 12, wherein the first group of shift register units is used to receive a first signal and the second group of shift register units is used to receive a second signal.

15. The driving circuit according to claim 14, wherein the directions for passing the first signal and the second signal are different.

16. The driving circuit according to claim 14, wherein the directions for passing the first signal and the second signal are the same.

17. The driving circuit according to claim 12, wherein the numbers of the shift register units in the first group of shift register units and the second group of shift register units are different.

18. The driving circuit according to claim 12, wherein the numbers of the shift register units in the first group of shift register units and the second group of shift register units are the same.

19. The driving circuit according to claim 12, further comprising:
a second switching circuit electrically connected between the second group of shift register units to divide the second group of shift register units into a third group of shift register units and a fourth group of shift register units, wherein the second switching circuit selectively disconnects the third group of shift register units from the fourth group of shift register units.
